(19) United States
(12) Patent Application Publication
(10) Pub. No.: US 2021/0097510 A1
(43) Pub. Date: Apr. 1, 2021

(54) Systems, Devices, and/or Methods for Managing Cryptocurrency Transactions

(71) Applicant: Jacob McDaniel, Salem, VA (US)

(72) Inventor: Jacob McDaniel, Salem, VA (US)

(21) Appl. No.: 17/033,822

(22) Filed: Sep. 27, 2020

Related U.S. Application Data
(60) Provisional application No. 62/906,167, filed on Sep. 26, 2019.

(51) Int. Cl. G06Q 20/06; G06Q 20/32; G06Q 20/10

(52) U.S. Cl. CPC G06Q 20/065; G06Q 20/102; G06Q 20/3267

(57) ABSTRACT

Certain exemplary embodiments can provide a method. Certain exemplary embodiments cause money to be transferred to a payee, the money obtained via a sale of cryptocurrency, the cryptocurrency obtained via cryptocurrency mining, the payee one of a plurality of payees, the payee selected from the plurality of payees via an App.

### CROSS-REFERENCES TO RELATED APPLICATIONS

This application claims priority to, and incorporates by reference herein in its entirety, pending U.S. Provisional Patent Application Ser. No. 62/906,167 (Attorney Docket No. 1396-02), filed Sep. 26, 2019.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system 1000;

FIG. 2 is a block diagram of an exemplary embodiment of an information device 2000; and

FIG. 3 is a flowchart of an exemplary embodiment of a method 3000.

### DETAILED DESCRIPTION

Certain exemplary embodiments can provide a method. Certain exemplary embodiments cause money to be transferred to a payee, the money obtained via a sale of cryptocurrency, the cryptocurrency obtained via cryptocurrency mining, the payee one of a plurality of payees, the payee selected from the plurality of payees via an App.

Cryptocurrency is a decentralized system that enables the storing, accounting, and transfer of digital mediums of exchange. Cryptocurrency ownership is defined by an amount of cryptocurrency located at a digital public address that is accessible via a networked device. Cryptocurrency public addresses have an associated private key that allows for the transfer of value from that address via the cryptocurrency's decentralized digital accounting ledger. For example, Bitcoin is a cryptocurrency that uses Bitcoin as its unit of value denomination and the Bitcoin network as the mechanism for Bitcoin-denominated value transfer.

Amounts of Bitcoin and their location on the Bitcoin network (their address) are registered in a digital public ledger accessible via the networked device. The private key associated with any Bitcoin address is required for the transfer of Bitcoin from that address to another Bitcoin address. Any transfer of Bitcoin from one address to another is only considered valid once confirmed in multiple blocks by the participants in the transaction confirmation process that validates and represents the authority for the Bitcoin network's decentralized public ledger. Participants in the transaction confirmation process are rewarded for their work in updating the decentralized public ledger of cryptocurrency ownership to account for new Bitcoin transfers. In the case of Bitcoin, they are rewarded with Bitcoin itself or other cryptocurrencies (if mining pools are used), which is how Bitcoin (the unit of value) is produced. Other cryptocurrencies are “pre-mined” and the participants in the maintenance of the decentralized ledger are rewarded with fees paid in the cryptocurrency by the entity that “pre-mined” the cryptocurrency in question. Cryptocurrency can have a fixed number of units of the currency that will ever be in existence or may have a known rate of production of the number of new units of the cryptocurrency or may be a combination in which the rate of production is known and there is a fixed number of total units of the currency that will ever be produced.

In cryptocurrency networks, mining is a validation of transactions. For this effort, successful miners obtain new cryptocurrency as a reward. The reward decreases transaction fees by creating a complementary incentive to contribute to the processing power of the network. The rate of generating hashes, which validate any transaction, has been increased by the use of specialized machines such as field programmable gate arrays and application-specific integrated circuits running complex hashing algorithms like SHA-256 (SHA-256 is one of a set of cryptographic hash functions designed by the United States National Security Agency (NSA) and first published in 2001) and Scrypt (Scrypt is a password-based key derivation function created by Colin Percival, originally for the Tarsnap online backup service. The algorithm was specifically designed to make it costly to perform large-scale custom hardware attacks by requiring large amounts of memory. In 2016, the Scrypt algorithm was published by IETF as RFC 7914).

Some miners pool resources, sharing processing power over a network to split the reward according to the amount of work they contributed to the probability of finding a block. A “share” is awarded to members of the mining pool who present a valid partial proof-of-work.

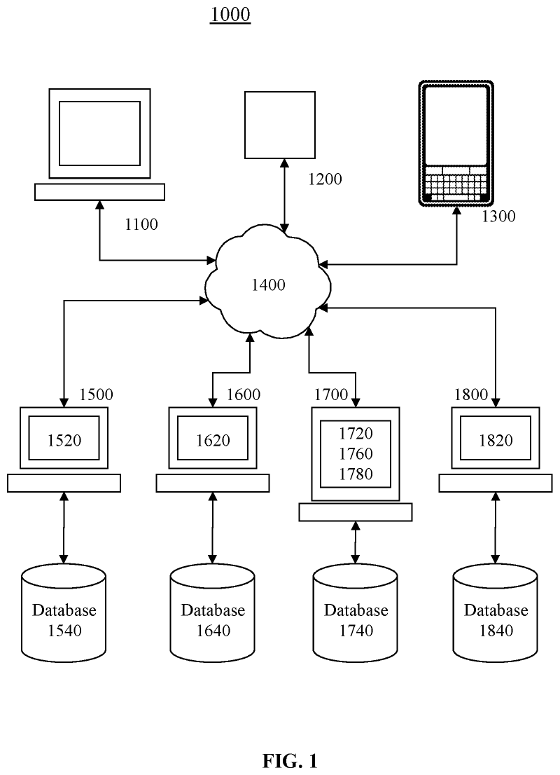

FIG. 1 is a block diagram of an exemplary embodiment of a system 1000, which can comprise a smartphone 1300, an information device 1100, tablet 1200, a network 1400, a first server 1500, a second server 1600, a third server 1700, and a fourth server 1800. First server 1500 can comprise a first user interface and/or integration 1520 and can be coupled to a first database 1540. Second server 1600 can comprise a second user interface and/or integration 1620 and can be coupled to a second database 1640. Third server 1700 can comprise a third user interface and/or integration 1720, a processor 1760, machine instructions 1780, and can be coupled to a third database 1740. Fourth server 1800 can comprise a fourth user interface and/or integration 1820 and can be coupled to a fourth database 1840. Any of the methods and/or steps thereof can be carried out in whole or in part by tablet 1200, smartphone 1300, information device 1100 and/or first server 1500. Second server 1600, third server 1700, and/or fourth server 1800 can each be associated with implementation of a system via which cryptocurrency is mined, sold, and/or transferred to a payee. In certain exemplary embodiments, system 1000 can be used to implement one or more methods disclosed herein.

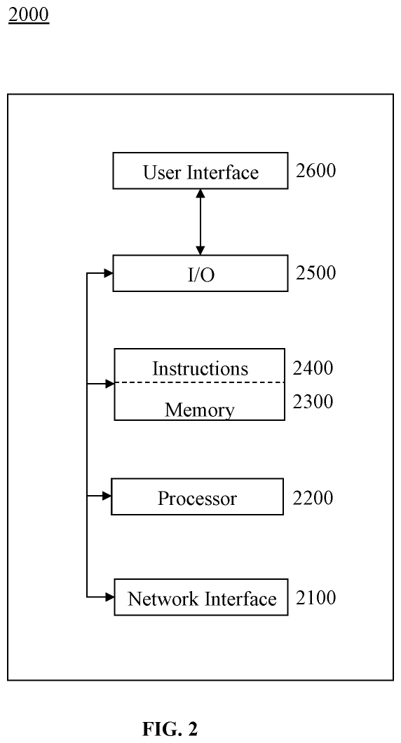

FIG. 2 is a block diagram of an exemplary embodiment of an information device 2000, which in certain operative embodiments can comprise, for example, information device 1100, of FIG. 1. Information device 2000 can comprise any of numerous circuits and/or components, such as for example, one or more network interfaces 2100, one or more processors 2200, one or more memories 2300 containing instructions 2400, one or more input/output devices 2500, and/or one or more user interfaces 2600 coupled to one or more input/output devices 2500, etc.

In certain exemplary embodiments, via one or more user interfaces 2600, such as a graphical user interface, a customer can view a rendering of information related to cryptocurrency mining and transfers of cryptocurrency obtained from mining.

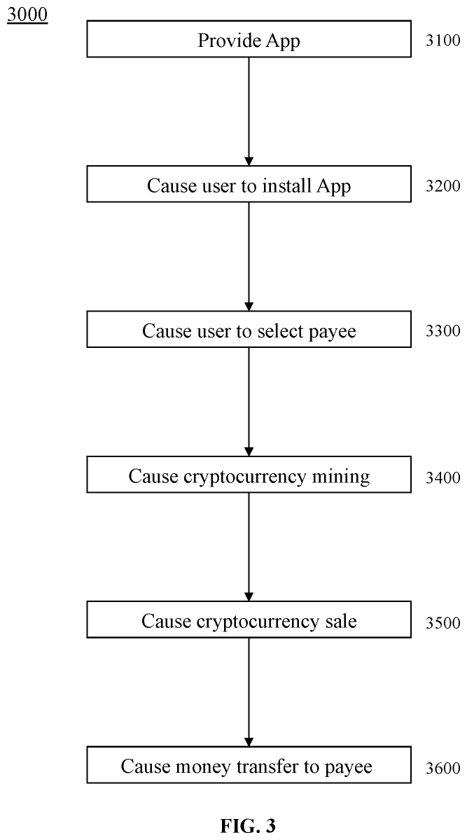

FIG. 3 is a flowchart of an exemplary embodiment of a method 3000. At activity 3100, application machine instructions (an “App”) can be provided to a user. The App can have a variety of capabilities. For example, the App can comprise machine instructions that participate in cryptocurrency mining and/or cryptocurrency mining pools for one or more predetermined cryptocurrencies. In other embodiments, the App can communicate with separate machine instructions that perform the cryptocurrency mining and/or participate in cryptocurrency mining pools. The App also comprises machine instructions that cause the App to be communicatively coupled to a database of payees. In certain exemplary embodiments, the database can be on a centralized server that is communicatively coupled to a plurality of Apps. In certain exemplary embodiments, the database of payees can comprise a predetermined set of entities. Any entity can be comprised in the predetermined set of entities. For example, the predetermined set of entities can comprise United Way Worldwide, Feeding America, Americares Foundation, Task Force for Global Health, Salvation Army, St. Jude Children's Research Hospital, Direct Relief, Habitat for Humanity International, Boys and Girls Clubs of America, and/or YMCA of the USA, etc.

At activity 3200, certain exemplary embodiments can cause the user to install the App. Installation of the App can involve the execution of machine instructions that cause the App to become communicatively coupled to the database of payees.

At activity 3300, certain exemplary embodiments can cause the user to select a payee. The user can be provided with a user interface that allows for a selection of a payee from a predetermined set of payees (e.g., charities) for proceeds of cryptocurrency mining. In certain exemplary embodiments, the centralized server can cause changes to the predetermined set of payees over time. In certain exemplary embodiments, the predetermined set of payees can be selected and/or rendered based upon a user preference of a class of payees from a predetermined class of payees (e.g., disaster relief charities could be a class of payees).

At activity 3400, certain exemplary embodiments can cause cryptocurrency mining to take place. The cryptocurrency mining can involve mining for one or more of Bitcoin, Bitcoin Cash, Litecoin, Ethereum, Zcash, Dash, Ripple, Monero, NEO, Cardano, and/or EOS, etc.

At activity 3500, certain exemplary embodiments can cause cryptocurrency to be sold. Certain exemplary embodiments can cause the automatic and/or manual sale of cryptocurrency proceeds from mining. In certain exemplary embodiments, the App and/or server can automatically communicate with one or more purchasing entities for cryptocurrency to convert the cryptocurrency to money. In certain exemplary embodiments, the App and/or server can communicate with an entity that communicates with one or more purchasing entities for cryptocurrency to convert the cryptocurrency to money

At activity 3600, certain exemplary embodiments can cause money from the cryptocurrency sale to be transferred to the payee. Certain exemplary embodiments can allow users of the App to automatically donate money to causes that those users deem worthy (e.g., charities). In certain exemplary embodiments, the App can be constructed to automatically transfer money obtained from the sale of cryptocurrencies to payees from the predetermined set of payees. In certain exemplary embodiments, the App can communicate with an entity that transfers money obtained from the sale of cryptocurrencies to payees from the predetermined set of payees.

Certain exemplary embodiments can:
cause money to be transferred to a payee, the money obtained via cryptocurrency obtained from service of a mining agent in a sale of cryptocurrency, the payee one of a plurality of payees, the payee selected from the plurality of payees via an App;
via the App, cause an information device to be a mining agent in cryptocurrency mining for the cryptocurrency;
cause a user to install the App;
cause a user interface to be rendered, the user interface providing a menu for a user to select the payee from the plurality of payees;
cause a user interface to be rendered, the user interface providing a menu for a user to change the payee;
cause a user interface to be rendered, the user interface providing a menu for a user to select a class of payees from a plurality of classes of payees;
cause the money obtained via a sale of cryptocurrency to be sold via the App;
cause proceeds obtained via the cryptocurrency mining to be converted to the money via the App; and/or
cause the cryptocurrency to be sold via the App and/or server.

Certain exemplary embodiments provide:
a database on a server that is communicatively coupled to a plurality of
Apps, the App comprised by the plurality of Apps, the database comprising information about the cryptocurrency; and/or
a database on a centralized server that is communicatively coupled to a plurality of Apps, the App comprised by the plurality of Apps, the database comprising information about the plurality of payees.

Certain exemplary embodiments provide machine-readable medium comprising machine-implementable instructions for activities comprising:
causing money to be transferred to a payee, the money obtained via cryptocurrency obtained from serving as a mining agent in a sale of cryptocurrency, the payee one of a plurality of payees, the payee selected from the plurality of payees via an App.

Certain exemplary embodiments provide a signal comprising machine instructions for activities comprising:
causing money to be transferred to a payee, the money obtained via cryptocurrency obtained from serving as a mining agent in a sale of cryptocurrency, the payee one of a plurality of payees, the payee selected from the plurality of payees via an App.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
and/or—either in conjunction with or in alternative to.
App—machine instructions constructed to carry out a particular task. An
App is often used on a smartphone or tablet type information device.
apparatus—an appliance or device for a particular purpose
associate—to join, connect together, and/or relate.
automatically—acting or operating in a manner essentially independent of external influence or control. For example, an automatic light switch can turn on upon “seeing” a person in its view, without the person manually operating the light switch.
can—is capable of, in at least some embodiments.
cause—something that produces an effect, result, or condition.
change—to make different.
circuit—an electrically conductive pathway and/or a communications connection established across two or more switching devices comprised by a network and between corresponding end systems connected to, but not comprised by the network.
class—set of things having some attribute in common and differentiated from others by kind, type, or quality.
comprising—including but not limited to.
configure—to make suitable or fit for a specific use or situation.
constructed to—made to and/or designed to.
convert—to transform, adapt, and/or change.
cryptocurrency—a digital asset designed to work as a medium of exchange that uses strong cryptography to secure financial transactions, control the creation of additional units, and verify the transfer of assets.
data—distinct pieces of information, usually formatted in a special or predetermined way and/or organized to express concepts.
database—a structured collection of data. A database comprises a group of records, each record containing related data that are stored in pre-defined fields.
define—to establish the outline, form, or structure of
determine—to obtain, calculate, decide, deduce, and/or ascertain.
device—a machine, manufacture, and/or collection thereof.
estimate—to calculate and/or determine approximately and/or tentatively.
generate—to create, produce, give rise to, and/or bring into existence.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
information—data that has been organized to express concepts.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
install—to connect or set in position and prepare for use.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
menu—a list of rendered options.
mine—to validate cryptocurrency transactions. For this effort, miners obtain cryptocurrency as a reward. The reward decreases transaction fees by creating a complementary incentive to contribute to the processing power of the network.
mining agent—an information device that participates in validating cryptocurrency transactions.
money—any item or verifiable record that is generally accepted as payment for goods and services and repayment of debts in a particular country or socio-economic context.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
obtain—to receive.
payee—an entity to which money is conveyed.
plurality—the state of being plural and/or more than one.
predetermined—established in advance.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
project—to calculate, estimate, or predict.
provide—to furnish, supply, give, and/or make available.
receive—to get as a signal, take, acquire, and/or obtain.
recommend—to suggest, praise, commend, and/or endorse.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
sale—an exchange of something for money.
select—to choose from a plurality of alternatives.
serve—to perform an activity for the benefit of another.
server—an information device and/or software that provides some service for other connected information devices via a network.
set—a related plurality.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
sold—exchanged for money.
store—to place, hold, and/or retain data, typically in a memory.
substantially—to a great extent or degree.
system—a collection of mechanisms, devices, machines, articles of manufacture, processes, data, and/or instructions, the collection designed to perform one or more specific functions.
transfer—a change of ownership one entity to another.
transmit—to send as a signal, provide, furnish, and/or supply.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
causing money to be transferred to a payee, the money obtained via cryptocurrency obtained from service of a mining agent in a sale of cryptocurrency, the payee one of a plurality of payees, the payee selected from the plurality of payees via an App.

2. The method of claim 1, further comprising:
via the App, causing an information device to be a mining agent in cryptocurrency mining for the cryptocurrency.

3. The method of claim 1, further comprising:
causing a user to install the App.

4. The method of claim 1, further comprising:
causing a user interface to be rendered, the user interface providing a menu for a user to select the payee from the plurality of payees.

5. The method of claim 1, further comprising:
causing a user interface to be rendered, the user interface providing a menu for a user to change the payee.

6. The method of claim 1, further comprising:
causing a user interface to be rendered, the user interface providing a menu for a user to select a class of payees from a plurality of classes of payees.

7. The method of claim 1, further comprising:
via the App, causing the money obtained via the sale of cryptocurrency.

8. The method of claim 1, further comprising:
causing proceeds obtained via the cryptocurrency mining to be converted to the money via the App.

9. The method of claim 1, further comprising:
causing the cryptocurrency to be sold via the App.

10. The method of claim 1, wherein:
a database on a server that is communicatively coupled to a plurality of Apps, the App comprised by the plurality of Apps, the database comprising information about the cryptocurrency.

11. The method of claim 1, wherein:
a database on a centralized server that is communicatively coupled to a plurality of Apps, the App comprised by the plurality of Apps, the database comprising information about the plurality of payees.

12. A machine-readable medium comprising machine-implementable instructions for activities comprising:
causing money to be transferred to a payee, the money obtained via cryptocurrency obtained from serving as a mining agent in a sale of cryptocurrency, the payee one of a plurality of payees, the payee selected from the plurality of payees via an App.

13. A signal comprising machine instructions for activities comprising:
causing money to be transferred to a payee, the money obtained via cryptocurrency obtained from serving as a mining agent in a sale of cryptocurrency, the payee one of a plurality of payees, the payee selected from the plurality of payees via an App.
